(19) United States
(12) Patent Application Publication
(10) Pub. No.: US 2021/0205055 A1
(43) Pub. Date: Jul. 8, 2021

(54) TECHNIQUES FOR PRODUCING REMOVABLE PARTIAL DENTURES VIA ADDITIVE FABRICATION AND RELATED SYSTEMS AND METHODS

(71) Applicant: Formlabs, Inc., Somerville, MA (US)

(72) Inventors: William Slocum, JR., Canton, MA (US); Gideon Balloch, Cambridge, MA (US)

(73) Assignee: Formlabs, Inc., Somerville, MA (US)

(21) Appl. No.: 17/124,918

(22) Filed: Dec. 17, 2020

Related U.S. Application Data
(60) Provisional application No. 62/950,003, filed on Dec. 18, 2019.

(51) Int. Cl. A61C 13/00; A61C 13/08; A61C 13/34

(52) U.S. Cl. CPC A61C 13/0004; A61C 13/34; A61C 13/08; A61C 13/0019

(57) ABSTRACT

Techniques for producing removable partial dentures (RPDs) through additive fabrication are described. According to some aspects, techniques are described by which a denture base may be additively fabricated in several separate portions and combined with a frame to form a completed denture base without the use of a refractory model. The denture base portions may be combined with a frame that was also produced through additive fabrication, or with a frame produced through traditional techniques. By creating an RPD through additive manufacturing it may be possible to eliminate many of the manual fabrication steps requiring highly-skilled and technical labor. This may reduce the total skilled labor time required in the production of RPDs, and/or may allow for repeatable and consistent results.

### CROSS REFERENCE TO RELATED APPLICATIONS

The present application claims the benefit under 35 U.S.C. §119(e) of U.S. Provisional Patent Application No. 62/950,003, filed Dec. 18, 2019, titled “Techniques For Producing Removable Partial Dentures Via Additive Fabrication And Related Systems And Methods,” which is hereby incorporated by reference in its entirety.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as stereolithography, solid objects are created by successively forming thin layers of a curable polymer resin, typically first onto a substrate and then one on top of another. Exposure to actinic radiation cures a thin layer of liquid resin, which causes it to harden, change physical properties, and adhere to previously cured layers or the bottom surface of the build platform.

### SUMMARY

According to some aspects, a computer-implemented method is provided of generating three-dimensional models for additive fabrication of a removable partial denture, the method comprising obtaining, using at least one processor, a 3-dimensional (3D) model of a denture base of a removable partial denture, generating, using the at least one processor, at least a first 3D model and a second 3D model each representing a portion of the 3D model of the denture base of the removable partial denture, wherein generating the first 3D model and the second 3D model comprises geometrically dividing the 3D model of the denture base of the removable partial denture.

According to some aspects, a removable partial denture is provided comprising a first denture base portion, a second denture base portion, and a frame, wherein the first denture base portion is coupled to the second denture base portion, with at least a portion of the frame being encapsulated by the coupled first and second denture base portions.

According to some aspects, a computer-implemented method is provided of dynamically designing a three-dimensional model of a denture base, the method comprising obtaining a three-dimensional model of a tooth, and generating, using at least one processor, a three-dimensional model of a denture base comprising a socket configured to receive the tooth, said generating comprising determining a depth of a buccal surface of the socket based at least in part on a depth of a buccal surface of the tooth and based at least in part on a target subgingival depth of the buccal surface of the tooth.

According to some aspects, a computer-implemented method is provided of dynamically designing a three-dimensional model of a denture base based on a three-dimensional model of a tooth, the method comprising generating, using at least one processor, a three-dimensional model of an adjusted tooth, the adjusted tooth being generated based on the tooth and on a subgingival margin line for the tooth, and generating, using the at least one processor, a three-dimensional model of a denture base comprising a socket configured to receive the adjusted tooth, said generating comprising determining a depth of a buccal surface of the socket based at least in part on a depth of a buccal surface of the tooth and based at least in part on a target subgingival depth of the buccal surface of the tooth.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B depict upper and lower views, respectively, of an illustrative removable partial denture (RPD);

FIG. 2 illustrates a flowchart of a method of fabricating an RPD via traditional techniques;

FIG. 3A is a flowchart of a method of generating three-dimensional models for additive fabrication of a removable partial denture, according to some embodiments;

FIG. 3B is a flowchart of a method of additive fabrication of a removable partial denture, according to some embodiments;

FIGS. 4A-4D depict a process of geometrically dividing a 3D model of a denture base to produce 3D models of portions of the denture base, according to some embodiments;

FIGS. 5A-5D depict a process of geometrically dividing a 3D model of a denture base to produce 3D models of portions of the denture base, according to some embodiments;

FIG. 6 depicts a cross-sectional view of 3D models of portions of a denture base that include mating structures, according to some embodiments;

FIG. 7 is a flowchart of a method of designing and fabricating a denture via additive fabrication, according to some embodiments;

FIG. 8 is a three-dimensional perspective view of a denture base comprising sockets, according to some embodiments;

FIG. 9 is a schematic of a conventionally-shaped denture tooth mated with a conventionally-shaped denture base;

FIG. 10 is a schematic of a denture tooth mated with a denture base according to some embodiments;

FIG. 11 is an exploded view of the denture tooth and denture base of FIG. 10;

FIG. 12 is a schematic of a denture tooth mated with a denture base according to some embodiments;

FIG. 13 is a schematic of a denture tooth mated with a denture base according to some embodiments;

FIG. 14 is a schematic of a denture tooth mated with a denture base according to some embodiments;

FIG. 15 is a schematic of a denture tooth mated with a denture base according to some embodiments;

FIG. 16 is a schematic of a denture tooth and a denture base having mating features according to some embodiments;

FIG. 17 is a schematic of a denture tooth and a denture base having mating features according to some embodiments;

FIG. 18 is a block diagram of a system suitable for practicing aspects of the invention, according to some embodiments; and

FIG. 19 illustrates an example of a computing system environment on which aspects of the invention may be implemented.

### DETAILED DESCRIPTION

Dentures are traditionally fabricated using a refractory model of a patient's mouth, which is typically obtained by casting the refractory model from an impression of the mouth. In some cases, a technician may form a wax base on the refractory model and arrange denture teeth within the wax. The combination of these elements can then be invested in stone and the wax melted so that a denture base, made from material such as acrylic, can be poured into the cavity left by removal of the wax.

Removable partial dentures are a type of denture made for patients that are missing only some teeth on a particular arch, but are unable to have a bridge as part of the denture for some reason, which would allow the denture to be fixed in place. Patients can remove and reinsert a removable partial denture (RPD) without help from a dental professional. These dentures typically include some kind of frame material, which is often metal, onto which traditional denture material and teeth are formed. For instance, an RPD may comprise a few teeth (e.g., four teeth) arranged on a denture base (representing gingiva) that has been cast around a metal frame.

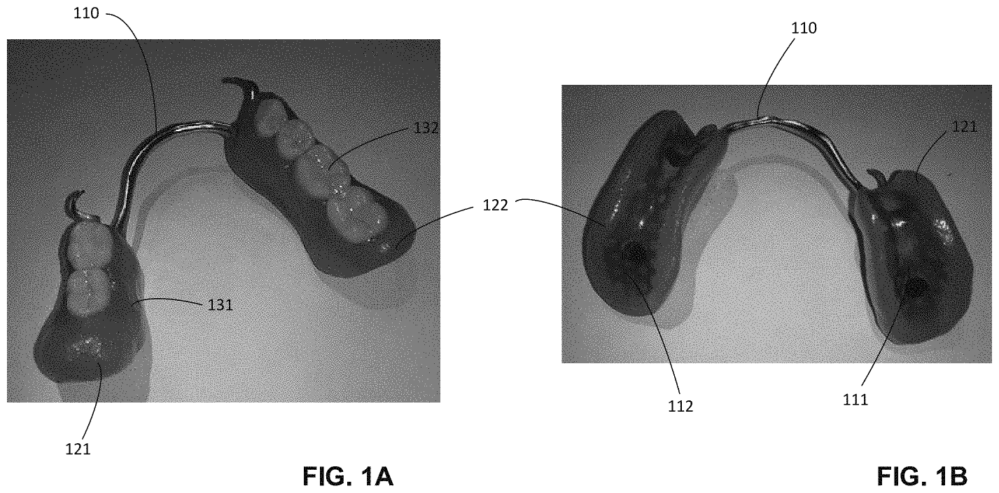

An illustrative example of an RPD is shown in FIGS. 1A and 1B, which show upper and lower views, respectively. The depicted RPD includes frame 110, which is embedded within denture bases 121 and 122. The portions of the frame 110 that are embedded within each denture base have a pattern of holes and are labeled 111 and 112 in FIG. 1B. Each of denture base 121 and 122 includes respective embedded teeth 131 and 132.

RPDs are traditionally fabricated similarly to the above-described process for full dentures, but generally require additional steps in which multiple refractory models are produced and/or in which the metal frame is created. In fabricating an RPD via this approach, the wax base is formed on a refractory model after first arranging an RPD frame and denture teeth on the model. When the lost wax casting process is performed, the frame becomes embedded within the denture base.

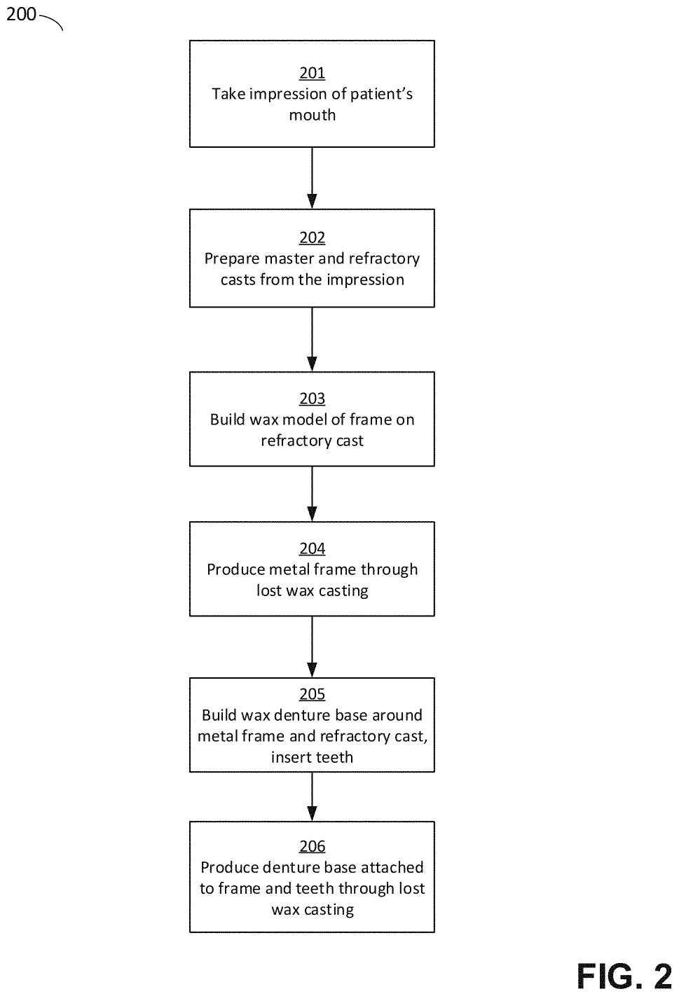

As one example, FIG. 2 illustrates a flowchart of a method of fabricating an RPD via traditional techniques. In act 201 of method 200, an impression is taken of a patient's mouth, typically by making a negative imprint of the patient's teeth and gums in an alginate material. In act 202, a (positive) master cast is made from the impression, and subsequent refractory casts made from the master. In act 203, the RPD begins to be designed by designing the frame portion on a refractory cast using wax. In act 204, the frame can be cast from metal through a lost wax casting method. In act 205, a second wax denture base is designed on a second refractory cast, this time incorporating the metal frame and denture teeth into the denture base design. As a result, when the denture base is cast through lost wax casting in act 206, the resulting denture base is connected to the teeth and to the frame.

The above-described process of method 200 is generally a laborious process that requires many steps and a great deal of post-processing. For instance, the frame is typically designed with a sprue that must be removed, and the metal frame is typically finished and polished before designing the rest of the denture base. In addition, the laborious and time-consuming lost wax casting methods are performed twice to produce a completed RPD. These steps may require a high level of skill and experience with the techniques to produce a workable RPD. Moreover, the highly manual creation process of method 200 may also lead to inconsistent or non-repeatable results in that the same process may never yield exactly the same RPD, even if performed twice by the same experienced technician.

The inventors have recognized and appreciated techniques for producing RPDs through additive fabrication. In particular, the inventors have recognized and appreciated techniques by which a denture base may be additively fabricated in several separate portions and combined with a frame to form a completed denture base without the use of a refractory model. The denture base portions may be combined with a frame that was also produced through additive fabrication, or with a frame produced through traditional techniques. By creating an RPD through additive manufacturing it may be possible to eliminate many of the manual fabrication steps requiring highly-skilled and technical labor. This may reduce the total skilled labor time required in the production of RPDs, and/or may allow for repeatable and consistent results.

In some cases, materials typically used in additive fabrication may lack the impact resistance, fracture resistance and/or durability to allow dentures to be fabricated from additive fabrication alone. The techniques described herein may allow RPDs to be produced from components that include both additively fabricated parts and non-additively fabricated parts. For instance, the frame of an RPD may be fabricated through traditional production techniques, whereas the denture base of the RPD may be produced through additive fabrication. In other cases, however, the components of an RPD may each be produced through one or more additive fabrication techniques.

According to some embodiments, a computing system may be configured to automatically generate 3-dimensional (3D) models for additive fabrication based on a 3D model of the denture base of an RPD. The automatic generation process may comprise geometrically dividing the model of the denture base into two or more 3D models each representing a portion of the denture base (and in some cases may also comprise generating a 3D model of a frame structure). Subsequent to fabrication of the two or more denture base portions through additive fabrication, the portions can be assembled around a frame to produce a denture base coupled to a frame to produce an RPD. For instance, two denture base portions could be attached to one another around a portion of the frame, with the portion of the frame passing through the interior of, and being encapsulated by, the combination of the two denture base portions.

According to some embodiments, generating 3D models of denture base portions by a computing system may comprise generating one or more mating structures for the models to aid in coupling the models subsequent to their fabrication. In some cases, pairs of denture base portions may be designed by the computing system with one or more complementary structures that may be mated together. Such structures may aid with proper relative positioning of the denture base portions (e.g., may guide the portions into proper position) and/or may increase the coupling strength between the denture base portions (e.g., by increasing the contact surface area). Such complementary structures may include any suitable mating features, such as plugs and sockets, and/or complementary textures. The structures may be configured to slide together, or may be configured to snap together such that mating between complementary structures may subsequent resist separation of the structures. In some embodiments the complementary structures may assist with alignment while subsequent adhesive steps provide separation resistance.

Following below are more detailed descriptions of various concepts related to, and embodiments of, techniques producing removable partial dentures via additive fabrication . It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

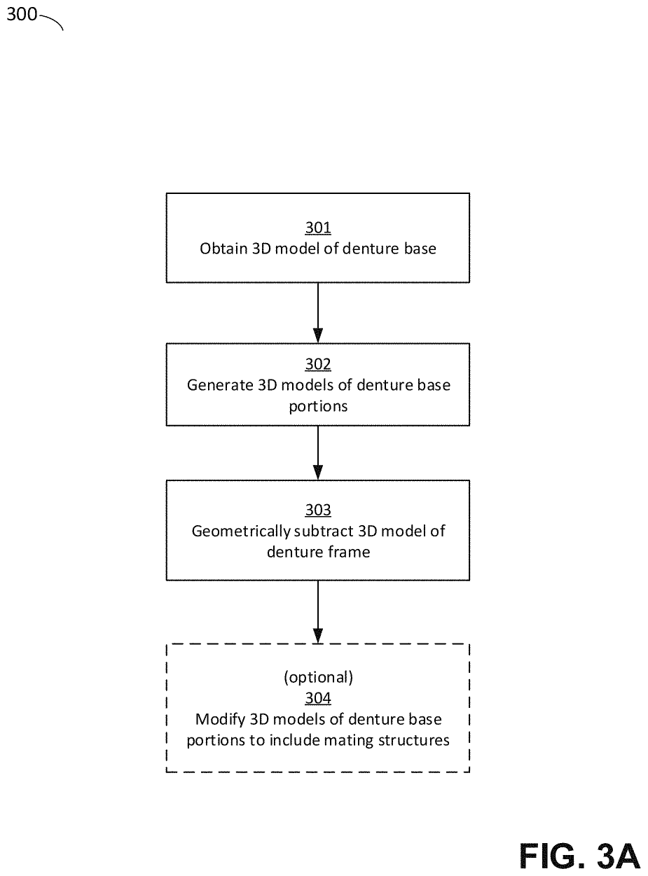

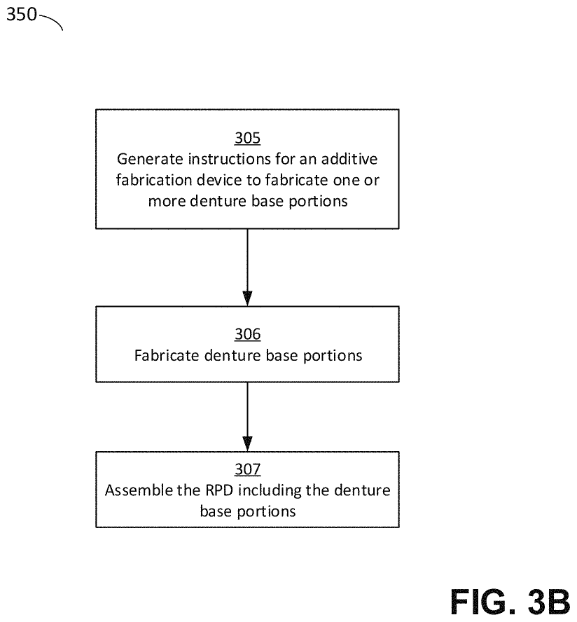

FIG. 3A is a flowchart of a method of generating three-dimensional models for additive fabrication of a removable partial denture, according to some embodiments. Method 300 may be performed by a suitable computing device, examples of which are described below. In some cases, method 300 may be performed by computer aided design (CAD) software (or any other software for designing 3D models). Such software may perform method 300 automatically (and in some cases with user input), and may be an integral part of the software package or may execute external to the software (e.g., may be a plug-in).

Method 300 begins in act 301 in which a 3D model of a denture base is obtained. In the context of act 301, obtaining the 3D model of the denture base may comprise reading a file describing the model from a storage device (including both non-volatile storage such as a disk drive and/or volatile storage such as a memory), or otherwise receiving data describing the 3D model (e.g., via a network connection).

In some embodiments, act 301 may comprise obtaining a 3D model of an RPD and generating a 3D model of the denture base from the 3D model of the RPD. In some cases, a model of a frame may also be generated from the 3D model of the RPD; in such cases, the 3D model of the RPD may, for instance, be split into denture base and frame models.

In act 302, a plurality of 3D models are generated that each represent a portion of the 3D model of the denture base. In some embodiments, act 302 may comprise geometrically dividing the 3D model of the denture base into a plurality of sub-models, which may each be processed to represent individual, closed models.

In some embodiments, the 3D models of the portions of the denture base may be generated and/or modified with reduced material at the interfaces between the portions to allow for an adhesive or other material to be introduced as an interface material between the portions when joining them together. For example, after geometrically dividing the 3D model of the denture base into two or more 3D models each representing a portion of the denture base, the computing device performing method 300 may identify surfaces of the portions that will contact one another during assembly of the fabricated portions. Each such surface may be moved toward the interior of the corresponding 3D model of the portion of the denture base by a distance based on the thickness of the interface material to be used. As a result of reducing the size of the portions to allow for interface material, the total volume of the 3D models of the portions of the denture base may be less than the total volume of the 3D model of the denture base.

In act 303, a 3D model of a denture frame is subtracted so that the generated 3D models of the portions of the denture base have carved out sections that will allow them to be joined together with the denture frame. Subtraction of the 3D model of the denture frame may be performed subsequent to act 302 as shown in FIG. 3A, such that a volume of one or more of 3D models of the denture base portions is removed by operating on the portion with the 3D model of the frame. In other cases, however, subtraction of the 3D model of the denture frame may be performed prior to act 302 so that the 3D models of the portions of the denture base are generated from a modified version of the 3D model of the denture base from which the frame has been subtracted. Examples of both approaches are described further below. In some embodiments, subtraction of the 3D model of the denture frame may comprise performing one or more Boolean operations on the 3D model of the denture frame combined with the 3D model of the denture base, and/or with 3D models of the portions of the denture base.

Irrespective of the ordering of acts 302 and 303, in the example of method 300 the result is to generate two or more 3D models each representing a portion of the denture base, and which combined include interior spaces so that the combination may be assembled around at least part of a denture frame. For instance, some of the 3D models of the portions of the denture base may include a surface channel into which a part of the frame may be seated, such that when the portions are additively fabricated and connected to one another during assembly, the portions encapsulate the part of the frame.

Optionally, method 300 comprises act 304 in which the generated 3D models are modified to include one or more mating structures. The mating structure may include any complementary structures generated on a pair of 3D models of portions of the denture base that can be mated together subsequent to fabrication of the portions. As discussed above, mating structures may aid with proper relative positioning of the denture base portions (e.g., may guide the portions into proper position) and/or may increase the coupling strength between the denture base portions (e.g., by increasing the contact surface area). Such complementary structures may include any suitable mating features, such as plugs and sockets. The structures may be configured to slide together, or may be configured to snap together such that mating between complementary structures may subsequent resist separation of the structures. It will be appreciated that act 304 need not be a separate act from acts 302 and/or 303, in that mating structures may, for instance, be generated as part the same operation in the 3D model of the denture base is geometrically divided.

It will be appreciated that an RPD may include multiple denture bases (as in the example of FIGS. 1A-1B), and as such while the above process may be performed for a single denture base of an RPD, the process may also be performed for multiple denture bases of the same RPD. In the latter case, different parts of the same 3D model of a denture frame may be considered when generating 3D models of portions of a first denture base and when generating 3D models of portions of a second denture base.

FIG. 3B is a flowchart of a method of additive fabrication of a removable partial denture, according to some embodiments. Method 350 may be performed subsequent to method 300 of FIG. 3A and comprises additive fabrication of portions of a denture base based on 3D models of the same, as may have been generated in method 300 as described above.

In act 305 of method 350, a suitable computing device generates instructions for an additive fabrication device that, when executed by the additive fabrication device, fabricates one or more denture base portions. The computing device may be executing the same software as may have executed method 300, or may be a different type of software. In some embodiments, act 305 may be performed by a processor executing software configured to connect to an additive fabrication device and prepare instructions for said additive fabrication device to fabricate one or more objects based on one or more 3D models and user input. In some cases, act 305 comprises a user accessing previously prepared 3D models of portions of a denture base and instructing the computing device to generate instructions for a particular additive fabrication device to fabricate the portions.

In act 306, the instructions generated in act 305 may be executed by the additive fabrication device and the one or more denture base portions thereby fabricated by the additive fabrication device. Any suitable additive fabrication technology or technologies may be employed to fabricate the denture base in act 708 (and optionally, a denture frame), including but not limited to stereolithography or other additive fabrication techniques in which a liquid photopolymer is cured via application of actinic radiation. In cases where the denture base and frame are both fabricated in act 306, the denture base and frame may, or may not, be fabricated using the same additive fabrication technique(s).

In some embodiments, in cases in which a denture base frame is fabricated in act 306 or otherwise, the frame may be fabricated from a castable material. As referred to herein, a “castable” material refers to a material suitable for use in fabricating a master pattern for an investment casting process, and may include resin materials as well as partially wax-filled resin materials. In some embodiments, in cases in which a denture base frame is fabricated in act 306 or otherwise, the frame may be fabricated from a different material from the material of the denture base, such as a material that may be more flexible and/or have a higher modulus of elasticity than the denture base.

In some embodiments, the frame portion may be additively fabricated from a photopolymer resin having material characteristics suitable for the application, such as strength, flexibility, and/or ductility. For instance, the frame may be additively fabricated from suitable forms of PEEK Acetyl and/or PMMA via a suitable additive fabrication technique.

In act 307, an RPD is assembled and may include the additively fabricated denture base portions fabricated in act 306. In some cases, the RPD may also include other components such as a denture frame. In some embodiments, joining additive fabricated denture base portions may comprise applying an adhesive to one or more of the portions and affixing the portions together. In some embodiments, the additive fabricated denture base portions may have been formed from a liquid photopolymer (e.g., via a stereolithographic additive fabrication process). Additional liquid photopolymer may be applied to an interface between the portions and they may be affixed together. Subsequently, the liquid at the interface may be cured by application of actinic radiation that at least partially penetrates the denture base portions. The result of this process may be a monolithic denture base that is composed of the same material throughout (or at least on either side of where the interface was located).

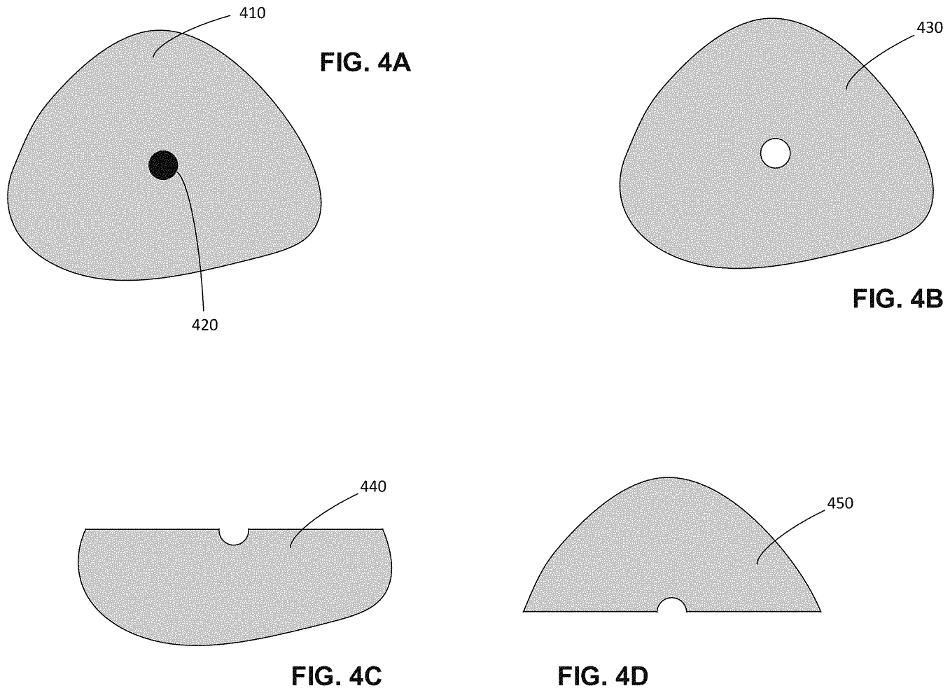

FIGS. 4A-4D depict a process of geometrically dividing a 3D model of a denture base to produce 3D models of portions of the denture base, according to some embodiments. FIG. 4A is a cross-sectional view through a 3D model of a denture base 410, wherein a 3D model of a denture frame 420 is arranged to pass through the interior of the denture base. In the example of FIGS. 4A-4D, the 3D model of the denture frame 420 is geometrically subtracted from the 3D model of the denture base (e.g., via one or more Boolean operations), producing 3D model 430 shown in the cross-sectional view of FIG. 4B. Subsequently, the 3D model 430 may be geometrically divided into 3D models of denture base portions 440 and 450, shown in the cross-sectional views of FIGS. 4C and 4D, respectively.

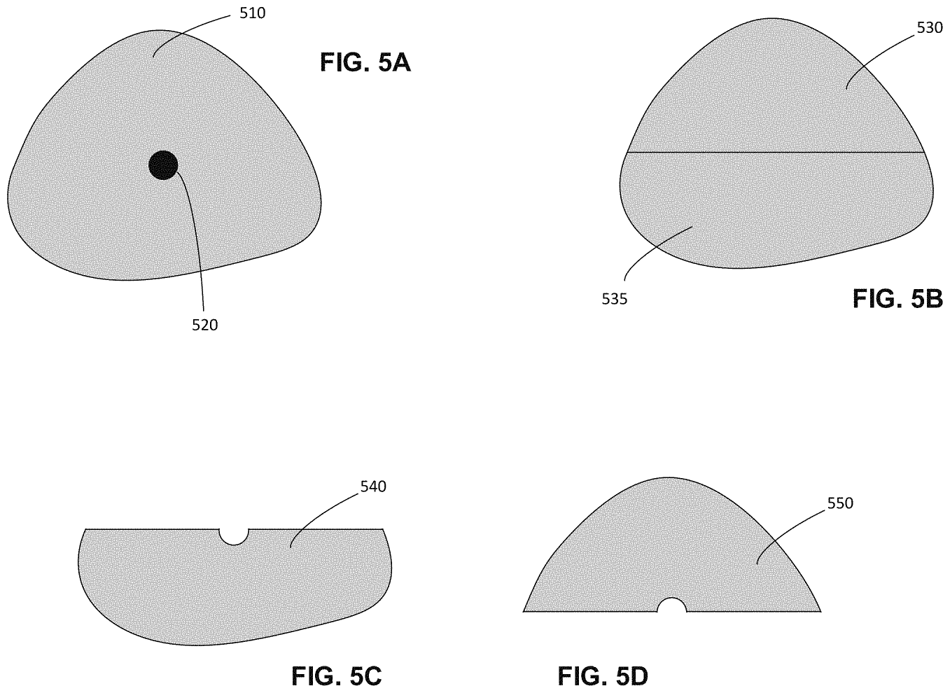

FIGS. 5A-5D depict a process of geometrically dividing a 3D model of a denture base to produce 3D models of portions of the denture base, according to some embodiments. FIG. 5A is a cross-sectional view through a 3D model of a denture base 510, wherein a 3D model of a denture frame 520 is arranged to pass through the interior of the denture base. In the example of FIGS. 5A-5D, the 3D model 510 may be geometrically divided into two 3D models of denture base portions 530 and 535, shown in the cross-sectional view of FIG. 5B. Subsequently, a part of the 3D model of the denture frame 520 is geometrically subtracted from each of the 3D models of the portions of the denture base (e.g., via one or more Boolean operations), producing 3D models of denture base portions 540 and 550, shown in the cross-sectional views of FIGS. 5C and 5D, respectively.

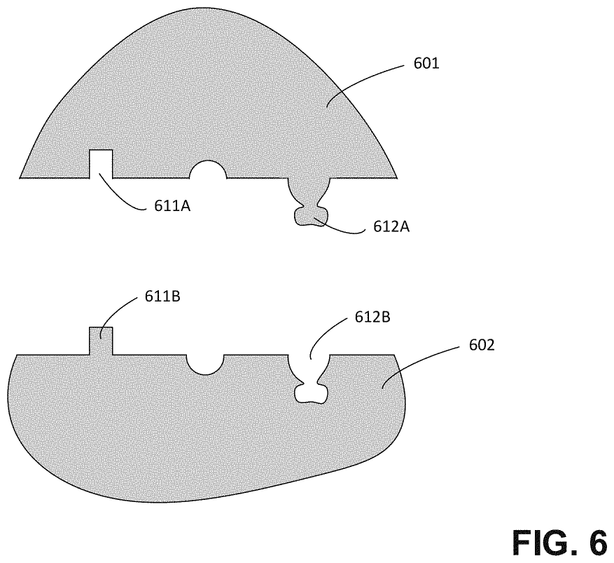

FIG. 6 depicts a cross-sectional view of 3D models of portions of a denture base that include mating structures, according to some embodiments. In the example of FIG. 6, portions 601 and 602 of a denture base are shown, which may for instance have been generated via either of the processes shown in FIGS. 4A-4D and FIGS. 5A-5D. Each of the portions 601 and 602 include mating structures, with the pair of portions 601 and 602 including two pairs of complementary structures. Mating structures 611A and 611B are configured so that part of the portion 602 may, once fabricated, be inserted into the portion 601.

In the example of FIG. 6, mating structures 612A and 612B are configured so that part of the portion 601 may, once fabricated, be inserted into the portion 602. Mating structures 612A and 612B are configured so that the male mating structure 612A may snap into the female mating structure 612B and thereby resist separation subsequent to being joined together.

In some embodiments, the male mating structure 611B may be configured to be slightly smaller than the female mating structure 611A so that the portions may be fit together without undue force being necessary. Similarly, male mating structure 612A may be configured to be slightly smaller than the female mating structure 612B.

In addition to the above-described techniques that allow additive fabrication of an RPD, the inventors have recognized and appreciated techniques for reducing the visible prominence of subgingival root structures through novel denture tooth designs. These designs may be particularly advantageous when fabricating a denture base via additive fabrication by fabricating a denture base that includes sockets into which teeth can be inserted. The size and shape of the sockets in the denture base may be determined based on three-dimensional models of the teeth that will be inserted into the denture base once it is fabricated. This approach allows teeth of a suitable size and shape to be arranged to protrude a decreased amount into the denture base at its buccal side, thereby reducing the visible prominence of subgingival root structures without it being necessary to increase the opacity of the denture base.

The techniques for reducing the visible prominence of subgingival root structures through novel denture tooth designs, described further below, may be applied in combination with the above-described techniques for additive fabrication of an RPD. In particular, once a 3D model of a denture base has been designed through the techniques described below, 3D models of portions of the denture base may be generated from the 3D model of the denture base as described above. In some cases, therefore, the above-described techniques may be based on a 3D model of a denture base that includes sockets for teeth generated as described below.

According to some embodiments, a three-dimensional model of a denture base may be generated based on three-dimensional models of teeth to be inserted into the denture base. The teeth and denture base may be fabricated together or separately using any suitable technology or technologies, including but not limited to additive fabrication. In some cases, for instance, a user may generate a three-dimensional model of a denture base based on three-dimensional models of teeth supplied by a third party, and may purchase prefabricated teeth matching the supplied three-dimensional models. The user may then additively fabricate a denture base according to the generated three-dimensional model of the denture base and insert the purchased prefabricated teeth into sockets formed within the denture base. In other cases, the user may additively fabricate both the denture base and the teeth according to three-dimensional models of the denture base and teeth, and then insert the teeth into sockets formed within the denture base.

According to some embodiments, a denture base may be generated to include sockets whose size and/or shape is determined based on a target subgingival depth. As used herein, a “socket” within a denture base refers to an open space within the denture base into which a tooth may be inserted. A socket may, or may not, be shaped to perfectly mate with a corresponding tooth; as discussed below there may be some cases in which a difference in shape is advantageous, such as for guiding or locking purposes.

As discussed above, techniques described herein allow teeth of a suitable size and shape to be arranged to protrude a decreased amount into the denture base at its buccal side, thereby reducing the visible prominence of subgingival root structures without it being necessary to increase the opacity of the denture base. As a result, when generating a three-dimensional model of a denture base based on a three-dimensional model of a tooth, the selected location of the tooth and the target subgingival depth of the tooth are considered. For instance, a target buccal subgingival depth may be 0.5 mm and consequently the three-dimensional model of a denture base may be generated to have a socket sized and shaped for a particular tooth, such that when the tooth is placed within the socket the tooth will have a subgingival depth of 0.5 mm at the buccal surface of the tooth.

According to some embodiments, a denture base may be generated to include sockets that include one or more guiding portions and/or mating portions. Since the teeth may be inserted into the denture base subsequent to the fabrication of the denture base (as compared with the conventional approach in which the denture base is formed around the teeth), it may be desirable to include structures that may guide teeth to an intended position and/or orientation within the denture base and/or that may allow the teeth to mate with the denture base. For instance, teeth may include protrusions that snap into cavities in the denture base, which may help to ensure that teeth are inserted into the denture base as intended. In some embodiments, three-dimensional models of teeth from which a three-dimensional model of a denture base is generated may include guiding and/or mating structures, and corresponding structures may be generated as part of the denture base model.

According to some embodiments, additively fabricated teeth and an additively fabricated denture base may be joined to one another using the same material from which the teeth and denture base were fabricated. For instance, teeth and a denture base fabricated through stereolithography, in which a liquid photopolymer is cured to a solid material, may be joined by applying additional liquid photopolymer between the teeth and denture base and curing this additional photopolymer. This may produce a strong chemical bond between the teeth and denture base since the resulting combined object is essentially a single monolithic part. Curing during such join operations may be performed automatically (e.g., by placing the teeth and denture base within a chamber that produces actinic radiation to cure the liquid photopolymer) or by manual operation (e.g., by directing a hand-held source of actinic radiation onto the liquid photopolymer).

According to some embodiments, a denture tooth and a corresponding denture base may be shaped to permit the buccal surface of the tooth to have a decreased subgingival depth. The inventors have appreciated that, in embodiments where the denture tooth is joined to the denture base, increased surface area of contact between the denture tooth and the denture base may help to increase bond strength between the denture tooth and the denture base. As such, according to some embodiments, a denture tooth and a corresponding denture base may be shaped to permit the buccal surface of the tooth to have a decreased subgingival depth while providing a sufficient surface area of contact between the denture tooth and the denture base. In some embodiments, the denture tooth and the corresponding denture base may be shaped to increase surface area of contact between the denture tooth and denture base at portions of the tooth excluding the buccal surface of the tooth, such as at the lingual or middle portions of the tooth.

As discussed above, the buccal surface of the tooth may have a target subgingival depth. In some embodiments, the target subgingival depth of the buccal surface of the tooth is less than a maximum subgingival depth of the tooth.

According to some embodiments, the denture tooth has a base surface extending between the buccal surface of the tooth to the lingual surface of the tooth. On the denture base side, the denture base may have a contact surface shaped to mate with the contours of the base surface of the denture tooth. The denture base may have a socket for receiving the denture tooth, in which case the socket has a contact surface extending from the buccal surface of the socket to a lingual surface of the socket.

A tooth may be viewed as being made up of thirds moving in a buccolingual direction, where the thirds comprise a buccal portion of the tooth, a middle portion of the tooth, and a lingual portion of the tooth. The base surface of the tooth may also be separated in such thirds. Similarly, a socket in a denture base may be viewed as being made up of thirds moving in a buccolingual direction, where the thirds comprise a buccal portion of the socket, a middle portion of the socket, and a lingual portion of the socket.

In some embodiments, the base surface of a denture tooth may be shaped such that the maximum subgingival depth of the tooth is located at the middle portion of the tooth or the lingual portion of the tooth. A denture base socket corresponding with such a tooth may have a maximum depth that is located at the middle portion of the socket or the lingual portion of the socket.

In some embodiments, a portion of the denture base may protrude into the denture tooth.

In some embodiments, the target subgingival depth of the buccal surface of the tooth is at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm or at least about 1.0 mm. In some embodiments, the target subgingival depth of the buccal surface of the tooth is less than or equal to about 1.0 mm, less than or equal to about 0.9 mm, less than or equal to about 0.8 mm, less than or equal to about 0.7 mm, less than or equal to about 0.6 mm, less than or equal to about 0.5 mm, less than or equal to about 0.4 mm, less than or equal to about 0.3 mm, less than or equal to about 0.2 mm, or less than or equal to about 0.1 mm. Combinations of the above-referenced ranges are also possible. For example, in some embodiments, the target subgingival depth of the buccal surface of the tooth is about 0.1 mm to about 1.0 mm, or about 0.2 mm to about 0.9 mm, or about 0.2 mm to about 0.8 mm, or about 0.2 to about 0.7 mm, or about 0.3 mm to about 0.6 mm, or about 0.3 mm to about 0.5 mm.

Following below are more detailed descriptions of various concepts related to, and embodiments of, techniques for generation of a denture base for additive fabrication and novel denture tooth designs. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

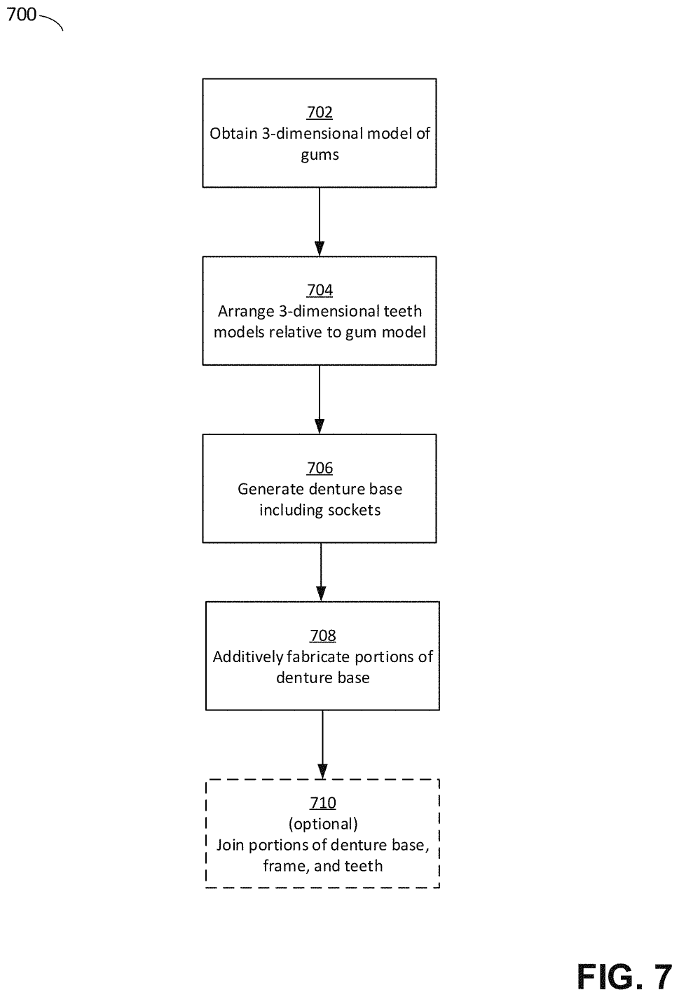

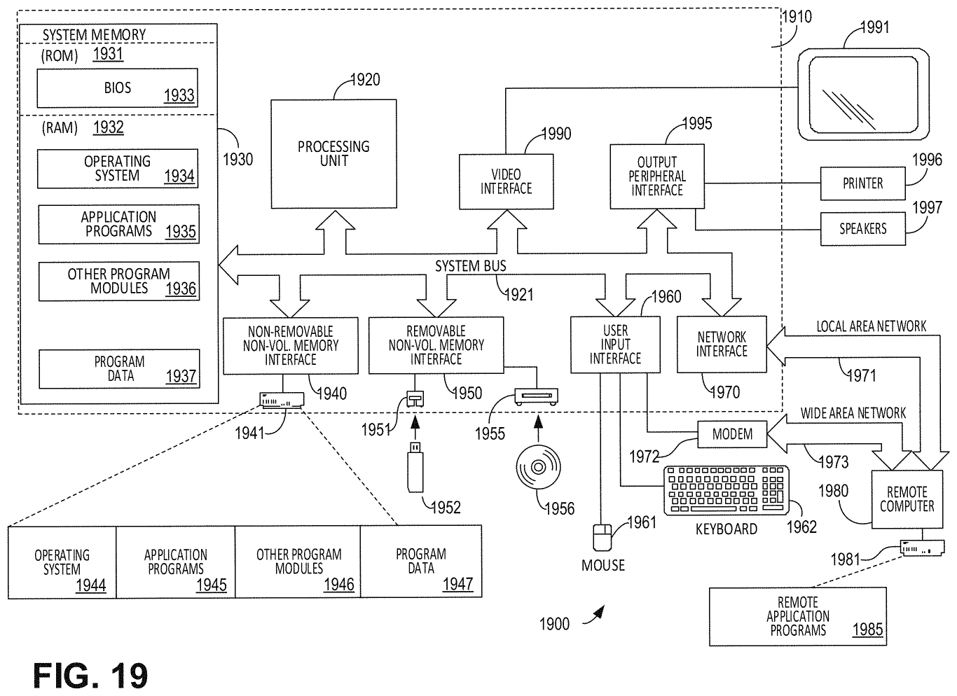

FIG. 7 is a flowchart of a method of designing and fabricating a denture via additive fabrication, according to some embodiments. Method 700 may be performed by any suitable combination of computing system(s) and/or additive fabrication device(s), an example of which is provided in FIG. 19 described below.

In act 702, a three-dimensional model of a patient's gums is obtained. Obtaining said model may comprise receiving data representing the model via a communication device and/or reading such data from one or more recordable storage media. The data may represent the three-dimensional model in any suitable way, including via Computer Aided Design (CAD) data formats and/or the STL file format. It will be appreciated that the three-dimensional model of gums obtained in act 702 may be represented by any number of data files or data structures so long as data descriptive of such a three-dimensional model is obtained.

The three-dimensional model of gums obtained in act 702 may represent some or all of a portion of a patient's gums into which teeth may be inserted. In some embodiments, the three-dimensional model of gums obtained in act 702 may represent the shape of the gum portion of a denture to be fabricated.

In some embodiments, obtaining the three-dimensional model of a patient's gums in act 702 may comprise generating a three-dimensional scan of the patient's mouth and/or an impression of the patient's mouth. For instance, a handheld scanner may be directed to various parts of the patient's teeth and gums and a computing device connected to the scanner may generate a three-dimensional model from a plurality of images captured by the scanner. In some embodiments, act 702 may comprise generating a three-dimensional model of a patient's gums by manipulating a three-dimensional model of the patient's teeth and gums (e.g., by separating out the teeth portions and smoothing the gum surface to produce a model of only the gum region).

In act 704, one or more three-dimensional models of teeth may be arranged with respect to the three-dimensional model of the patient's gums obtained in act 702. In some embodiments, act 704 may comprise manipulation, by a dental professional, of the three-dimensional models within software for manipulation of three-dimensional models, such as CAD software. Act 704 may be similar to a step in conventional denture fabrication in which the dental professional manually arranged the teeth within a wax model; in act 704, however, the arrangement of teeth is performed in a computing environment, such as via one or more graphical user interfaces (GUIs).

As with the three-dimensional model of the patient's gums obtained in act 702, data representing the three-dimensional model of one or more teeth may represent the teeth in any suitable way, including via Computer Aided Design (CAD) data formats and/or the STL file format. Further, the three-dimensional model of one or more teeth may be represented by any number of data files or data structures so long as data descriptive of such a three-dimensional model is obtained.

In some embodiments, the one or more three-dimensional models of teeth arranged in act 704 may be obtained from a library of prebuilt teeth models. A dental professional may, for instance, select desired teeth models from amongst a plurality of prebuilt teeth models and obtain data representing the selected teeth models by accessing or otherwise receiving said data. In some cases, the selected teeth models may be obtained from a third party.

In some embodiments, the one or more three-dimensional models of teeth arranged in act 704 may be generated by one or more computing devices based on the three-dimensional model of the patient's gums obtained in act 702. In some cases, said generation may comprise generating the one or more three-dimensional models of teeth based on supplied parameters defining aspects of the shapes of the teeth or defining other information on which the tooth shapes depend. As will be discussed below, techniques described herein include advantageous improvements to the shape of denture teeth and in some embodiments such shapes may be generated to produce the one or more three-dimensional models of teeth arranged in act 704. Generation of desired shapes may comprise generation of the entire tooth shape from scratch, or may comprise generation of the tooth shape by starting from another three-dimensional model of a tooth and modifying said model to produce the desired shape. For example, the one or more three-dimensional models of teeth arranged in act 704 may be generated by obtaining three-dimensional models of prebuilt teeth models from a library and modifying these teeth models to produce desired shapes.

According to some embodiments, the one or more three-dimensional models of teeth arranged in act 704 may comprise one or more guiding or mating features. Such features, examples of which are described further below, may be generated based on data supplied by a user (e.g., via one or more GUIs) indicating attributes of the features (e.g., size, width, etc.) and/or may be present within the three-dimensional models of teeth when obtained.

According to some embodiments, arranging the one or more three-dimensional models of teeth in act 704 may comprise automatically positioning one or more teeth models based on a target subgingival depth. As discussed above, techniques described herein allow teeth of a suitable size and shape to be arranged to protrude a minimal amount into the denture base at its buccal side, thereby reducing the visible prominence of subgingival root structures without it being necessary to increase the opacity of the denture base. Act 704 may comprise positioning and/or orienting, by one or more computing devices, one or more teeth models relative to the three-dimensional model of gums obtained in act 702. For example, the one or more teeth models may be positioned and/or oriented relative to a margin line of the three-dimensional model of gums obtained in act 702. In some embodiments, positioning and/or orienting a tooth model relative to the three-dimensional model of gums may be performed to produce a particular height of the subgingival portion of the tooth at the buccal side of the tooth. As used herein, “buccal” refers to the exterior-facing side of a tooth, sometimes also referred to as the facial or labial side.

In some embodiments, one or more graphical user interfaces being operated by a dental professional or other user to arrange the one or more three-dimensional models of teeth in act 704 may automatically position the teeth models along a height dimension based on a target subgingival depth. The user may specify a target subgingival depth for all teeth, for multiple teeth, or for each tooth individually, and the computing device(s) generating the one or more graphical user interfaces may determine a position along the height dimension so that the subgingival portion of a tooth exhibits the target subgingival depth with respect to the model of the patient's gums. This may, for instance, allow the user to position and/or orient teeth models by selecting only the position of each tooth along the gums and its orientation with respect to the gums, thereby simplifying the process of arranging the teeth.

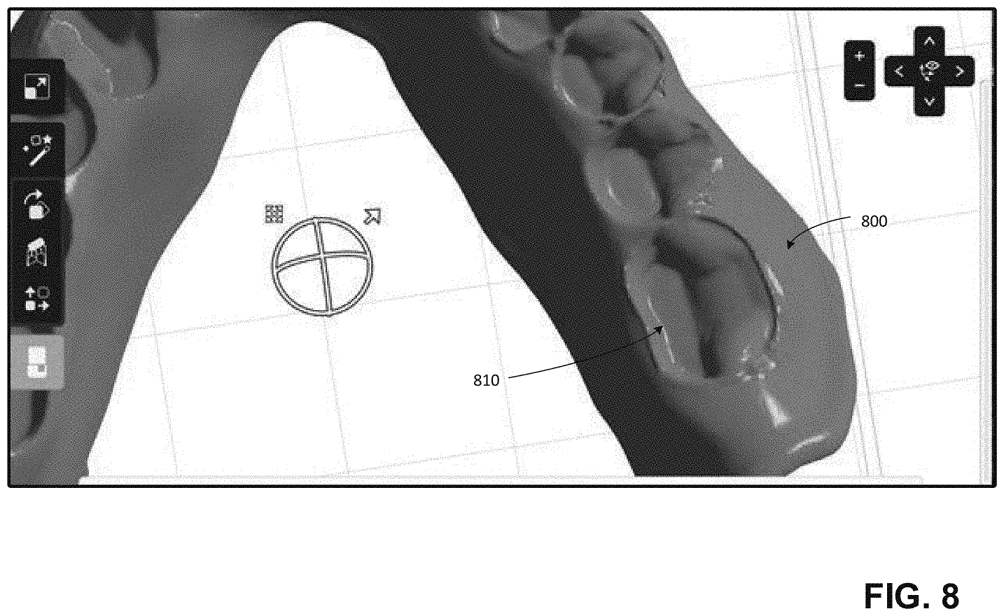

In act 706, a three-dimensional model of a denture base is generated based at least in part on the three-dimensional model of the gums obtained in act 702 and on the arrangement of the models of teeth with respect to the gums produced in act 704. The three-dimensional model of the denture base may comprise sockets into which fabricated teeth are to be inserted once the denture base is fabricated according to the model of the denture base. An example of such a model is depicted in FIG. 8, which illustrates a denture base 800 that includes sockets, of which socket 810 is an example.

According to some embodiments, the shapes of teeth to be fabricated and inserted into the sockets may, or may not, match the shapes of respective teeth models arranged in act 704. In some cases, for instance, the shapes of teeth utilized during the arrangement process of act 704 may be presented in such a way that a dental professional can easily understand how the teeth are positioned even if the shapes of the teeth in such presentation are not the same as the teeth that will be fabricated.

As one example, the three-dimensional models of teeth arranged in act 704 may comprise a full root structure that the dental professional can view during arrangement of the tooth models. Subsequent to said arrangement, however, one or more computing devices may modify portions of the subgingival part of the tooth models (or otherwise replace the arranged teeth models with modified teeth models) to produce denture teeth with more advantageously shaped teeth as described below. Accordingly, when the three-dimensional model of the denture base is generated the sockets therein may match these modified tooth models, and not the tooth models viewed by the dental professional during the arrangement process of act 704.

According to some embodiments, act 706 may comprise performing one or more Boolean operations with respect to three-dimensional shapes of the gums obtained in act 702 and one or more teeth models. For example, to generate the shape of a socket, regions of three-dimensional space in which a tooth model and the gum model overlap may be subtracted from the gum model to produce a gum model with a socket located and shaped as the tooth model's protrusion into the gum model. Teeth models utilized in act 706 to perform Boolean operations may, or may not, match the shapes of respective teeth models arranged in act 704 as discussed above.

According to some embodiments, one or more guiding or mating features may be generated for sockets of the denture base on act 706. Such features, examples of which are described further below, may be generated based on corresponding features within teeth to be inserted into the sockets and/or upon data supplied by a user (e.g., via one or more GUIs) indicating attributes of the features (e.g., size, width, etc.)

In act 708, a denture base is fabricated via additive fabrication according to the three-dimensional model of the denture base generated in act 706. Act 708 may comprise method 300; 3D models of portions of the denture base may be generated based on the model of the denture base generated in act 706, and the portions fabricated. At least one of these portions may comprise the sockets into which teeth are to be inserted. Teeth to be inserted into sockets of the fabricated denture base may be fabricated via additive fabrication according to three-dimensional models of such teeth, and/or may be obtained separately (e.g., from a third party). Any suitable additive fabrication technology or technologies may be employed to fabricate the denture base in act 708 (and optionally, one or more teeth), including but not limited to stereolithography or other additive fabrication techniques in which a liquid photopolymer is cured via application of actinic radiation. In cases where the denture base and teeth are both fabricated in act 708, the denture base and teeth may, or may not, be fabricated using the same additive fabrication technique(s).

Optionally, in act 710, the denture base fabricated in act 708 may be joined with one or more teeth by inserting said teeth into sockets of the denture base and affixing the teeth to the denture base. In some embodiments, adhesive may be applied to the sockets prior to insertion of the teeth. In some embodiments in which the denture base and/or teeth were fabricated by curing a liquid photopolymer via application of actinic radiation, additional photopolymer may be inserted into the socket prior to insertion of the teeth and subsequently curing by application of further actinic radiation to produce a monolithic part.

Illustrative examples of denture tooth shapes and corresponding denture base shapes are now described.

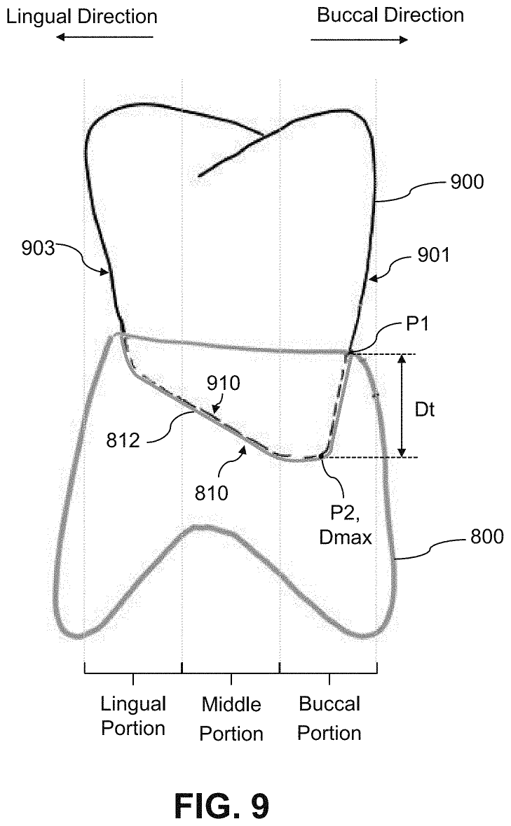

FIG. 9 depicts a schematic of a conventionally-shaped denture tooth mated with a conventionally-shaped denture base. The mesial aspect of the tooth is shown, with the lingual direction pointing toward the left and the buccal direction pointing toward the right. The denture tooth 900 protrudes into a socket 810 of the denture base 800. The subgingival depth of the buccal surface of the tooth is shown as dimension Dt. Dt is a vertical distance measured from the most coronal point P1 of the buccal side 801 of the denture base 800 where the tooth is located, down in the apical direction to the most apical point P2 of the buccal surface 901 of the tooth.

As shown in FIG. 9, the subgingival depth of the buccal surface of the tooth Dt is also the maximum subgingival depth Dmax of the tooth. As discussed above, due to this large protrusion depth of the tooth into the denture base at the buccal surface of the tooth, the subgingival root of the tooth may be visible through the denture base, making the denture look less aesthetically similar to native teeth. As also discussed above, increasing the opacity of the denture base to hide the subgingival root of the tooth can be an inadequate solution because such an approach can also make the denture base appear aesthetically different from real gingiva.

In FIG. 9, each of the denture tooth 900 and the denture socket 810 are divided into lingual, middle, and buccal portions. As best seen in FIG. 9, the maximum subgingival depth Dmax of the conventionally-shaped denture tooth is located in the buccal portion of the tooth.

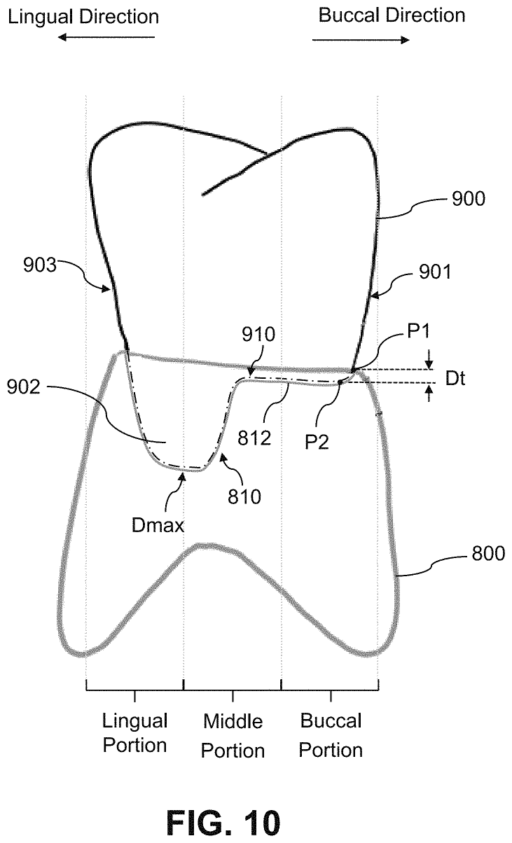

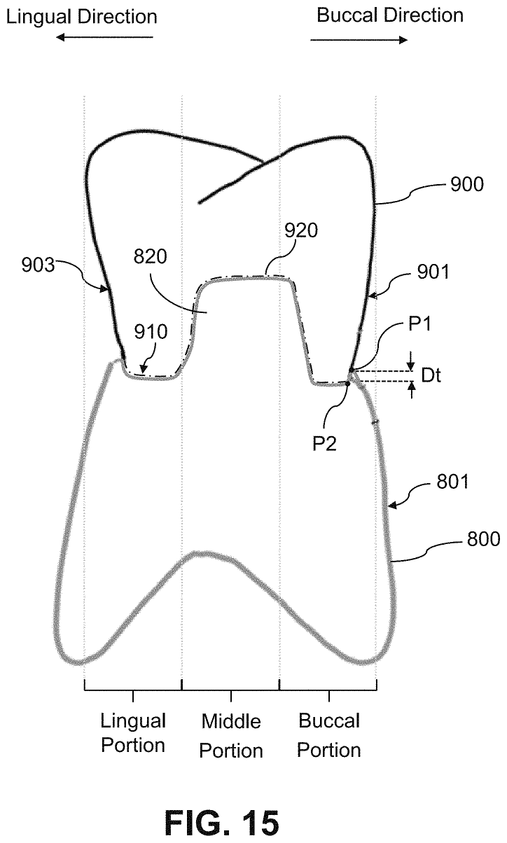

FIGS. 10-15 depict illustrative examples of denture tooth and denture base shapes that permit the denture tooth to protrude a decreased amount into the denture base at its buccal side as compared to the traditional tooth shape shown in FIG. 9, thereby reducing the visible prominence of subgingival root structures without it being necessary to increase the opacity of the denture base.

In the illustrative embodiment shown in FIG. 10, the denture tooth 900 has a base surface 910 extending from a buccal surface 901 to a lingual surface 903. The shape of the base surface 910 is different from that of the conventionally shaped denture tooth shown in FIG. 9. In the illustrative embodiment of FIG. 10, the base surface 910 of the tooth is inwardly concaved inwardly in the buccal portion and in part of the middle portion, and is convex outwardly in the lingual portion and in part of the middle portion. Correspondingly, the contact surface 812 of the denture base is convex outwardly in the buccal portion and in part of the middle portion, and is concave inwardly in the lingual portion and in part of the middle portion.

In the denture tooth of FIG. 10, the maximum subgingival depth Dmax of the tooth is located in the middle and lingual portions of the tooth, not in the buccal portion of the tooth. The subgingival depth of the tooth in the buccal portion of the tooth is reduced compared to the conventionally-shaped denture tooth of FIG. 9, and thus the subgingival depth of the tooth at the buccal surface of the tooth Dt is also reduced compared to that of FIG. 9. The subgingival depth of the tooth in the buccal portion may remain relatively constant at a small depth in the buccal portion, and may increase as the tooth transitions into the middle portion and the lingual portion. The protrusion 902 of the denture tooth into the denture base 800 at the lingual and middle portions may help to provide a surface area of contact between the denture tooth and the denture base to aid in bonding between the denture tooth and the denture base.

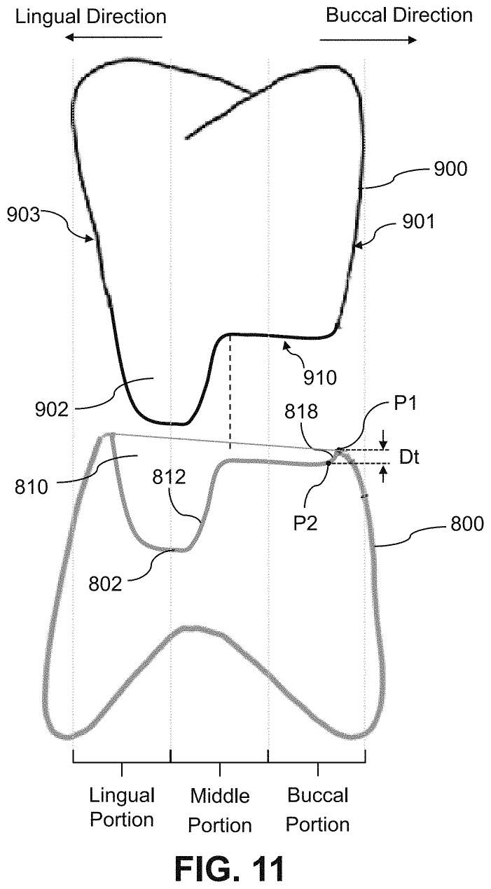

FIG. 11 shows an exploded view of the embodiment of FIG. 10 showing the denture tooth 900 separated from the denture base 800. In the illustrative embodiment of FIG. 11, the denture base 800 has a socket 810 for receiving the denture tooth 900. In some embodiments, the three-dimensional model of the denture base 800 is generated based on the three-dimensional model of the denture tooth 900. The shape of the denture base socket 810 may be generated based on a target buccal surface subgingival depth that is specified by a user or pre-set in a program. For example, as seen in FIG. 11, if the target buccal surface subgingival depth is set to Dt, the denture base socket 810 may be generated to include a socket having a depth Dt at the buccal surface 818 of the socket. The remaining contours and geometry of the contact surface 812 of the denture base socket 810 may be generated based on the shape of the rest of the base surface 910 of the denture tooth 900. For example, to accommodate the protrusion 902 of the denture tooth, the denture base socket 810 may be generated to include a concavity 802 shaped to accommodate the protrusion 902.

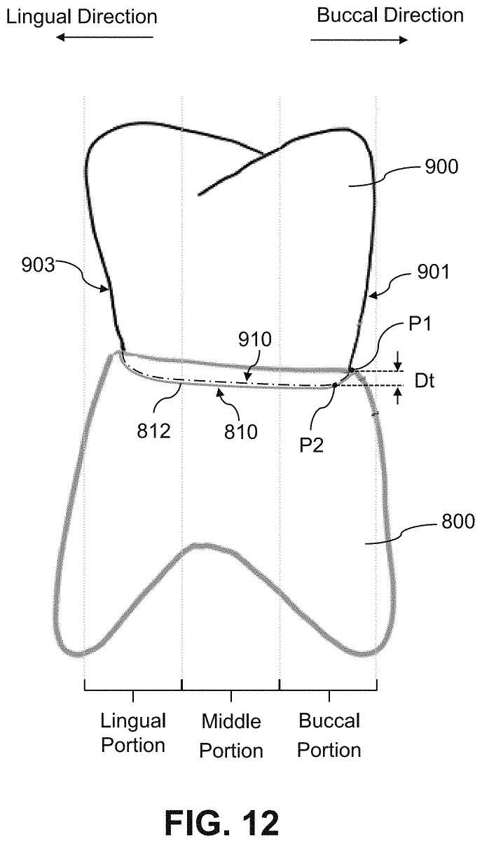

FIG. 12 shows another illustrative embodiment of a denture tooth 900 and an associated denture base 800. The shape of the base surface 910 of the denture tooth is different from that of the conventionally shaped denture tooth shown in FIG. 9. Instead of having a subgingival depth that varies greatly along the buccolingual direction of the tooth, the denture tooth 900 may have a subgingival depth that remains roughly the same in the buccal portion, middle portion, and lingual portion. The subgingival depth of the tooth in the buccal portion of the tooth is reduced compared to the conventionally-shaped denture tooth of FIG. 9, and thus the subgingival depth of the tooth at the buccal surface of the tooth Dt is also reduced compared to that of FIG. 9.

In some embodiments, the denture base and denture tooth are each fabricated from a liquid photopolymer and joined together by curing additional photopolymer at the interface between the base and tooth. While the area of contact between the base surface 910 and denture base socket 810 in the example of FIG. 6 may be minimal, or close to minimal, yet the chemical bond may nonetheless provide a suitably strong bond for a denture since, in such cases, the bond between the base and tooth is chemical in nature, not mechanical like a conventional bond between denture teeth and a denture base.

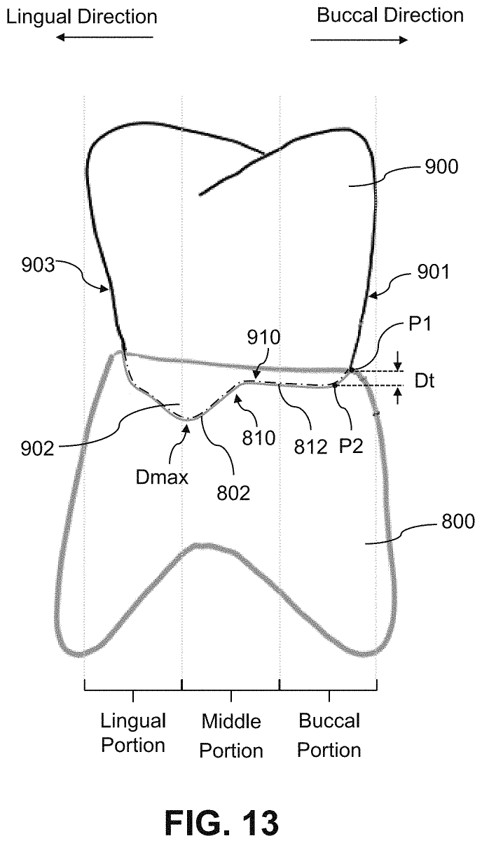

FIG. 13 shows another illustrative embodiment of a denture tooth 900 and associated denture base 800. The shape of the base surface 910 of the denture tooth is different from that of the conventionally shaped denture tooth shown in FIG. 9. In the illustrative embodiment of FIG. 7, the base surface 910 of the tooth is concaved inwardly in the buccal portion and in part of the middle portion, and is convex outwardly in the lingual portion and in part of the middle portion. Correspondingly, the contact surface 812 of the denture base is convex outwardly in the buccal portion and in part of the middle portion, and is concave inwardly in the lingual portion and in part of the middle portion.

The maximum subgingival depth Dmax of the tooth is located in the middle and lingual portions of the tooth, not in the buccal portion of the tooth. The subgingival depth of the tooth in the buccal portion of the tooth is reduced compared to the conventionally-shaped denture tooth of FIG. 9, and thus the subgingival depth of the tooth at the buccal surface of the tooth Dt is also reduced compared to that of FIG. 9. The deeper protrusion of the denture tooth 900 into the denture base 800 at the lingual and middle portions may help to provide a surface area of contact between the denture tooth and the denture base for bonding between the denture tooth and the denture base. In the embodiment shown in FIG. 13, the subgingival depth of the tooth in the buccal portion and the depth of the socket 810 may remain relatively constant at a small depth in the buccal portion, and may increase as the tooth transitions into the middle portion and the lingual portion.

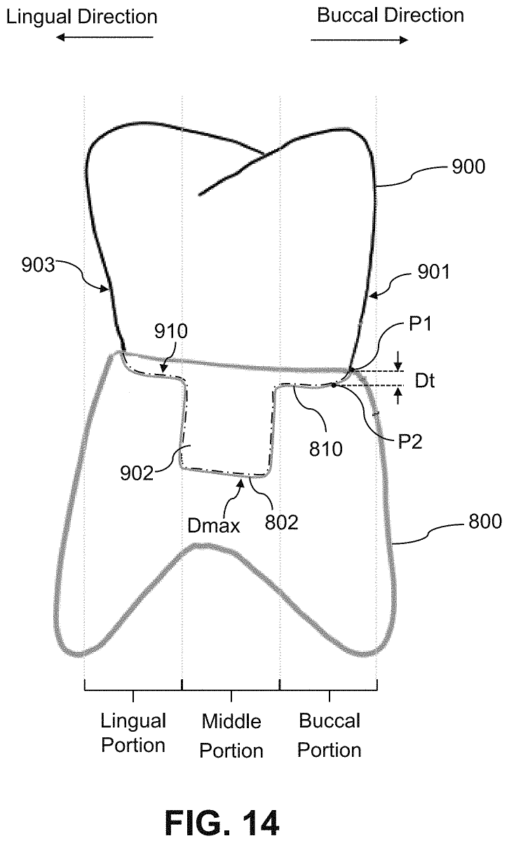

FIG. 14 shows another illustrative embodiment of a denture tooth 900 and associated denture base 800. The shape of the base surface 910 of the denture tooth is different from that of the conventionally shaped denture tooth shown in FIG. 9. In the illustrative embodiment of FIG. 8, the base surface 910 of the tooth is cutaway in the buccal portion and in the lingual portion, and is convex outwardly in the middle portion. Correspondingly, the contact surface 812 of the denture base is concave inwardly in the middle portion.

The maximum subgingival depth Dmax of the tooth is located in the middle portion of the tooth, not in the buccal portion of the tooth. The subgingival depth of the tooth in the buccal portion of the tooth is reduced compared to the conventionally-shaped denture tooth of FIG. 9, and thus the subgingival depth of the tooth at the buccal surface of the tooth Dt is also reduced compared to that of FIG. 9. The protrusion of the denture tooth 900 into the denture base 800 at the middle portion may help to provide a surface area of contact between the denture tooth and the denture base for bonding between the denture tooth and the denture base. In the embodiment shown in FIG. 8, the subgingival depth of the tooth in the buccal portion may increase as the tooth transitions from the buccal portion to the middle portion, and then may decrease again as the tooth transitions from the middle portion to the lingual portion of the tooth. In some embodiments, the transition in subgingival depth may be an abrupt step-wise transition rather than a gradual transition.

In some embodiments, at least a portion of the denture base may protrude into the denture tooth. Such an arrangement may help to increase bonding strength between the denture base and the denture tooth.

For example, in the illustrative embodiment is shown in FIG. 9, the denture base 800 includes a protrusion 820 that protrudes into a cavity 920 of the denture tooth 900. It should be noted that portions of the denture tooth 900 may still protrude into the denture base 800, such as at the buccal surface. The subgingival depth of the tooth in the buccal portion of the tooth is reduced compared to the conventionally-shaped denture tooth of FIG. 9, and thus the subgingival depth of the tooth at the buccal surface of the tooth Dt is also reduced compared to that of FIG. 9.

In some embodiments, the denture tooth and denture base may include mating features to aid in maintaining contact between the denture tooth and the denture base.

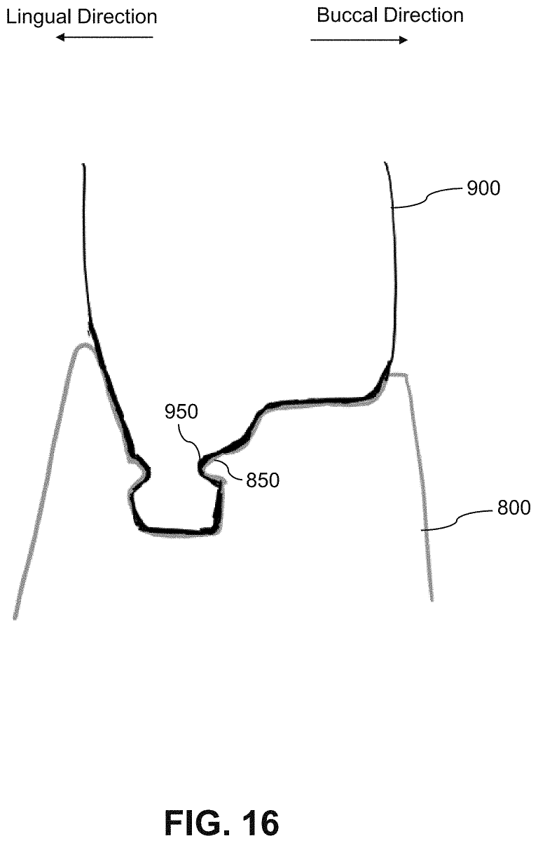

In one illustrative embodiment shown in FIG. 16, the denture tooth 900 and denture base 800 include mating features in the form of an indentation 950 on the tooth and a corresponding protrusion 850 on the denture base. In some embodiments, as the denture tooth is inserted into the socket of the denture base, and the protrusion 850 on the denture base snaps into the indentation 950 on the tooth. Mating between the protrusion 850 and indentation 950 may aid in resisting separation of the tooth from the denture base.

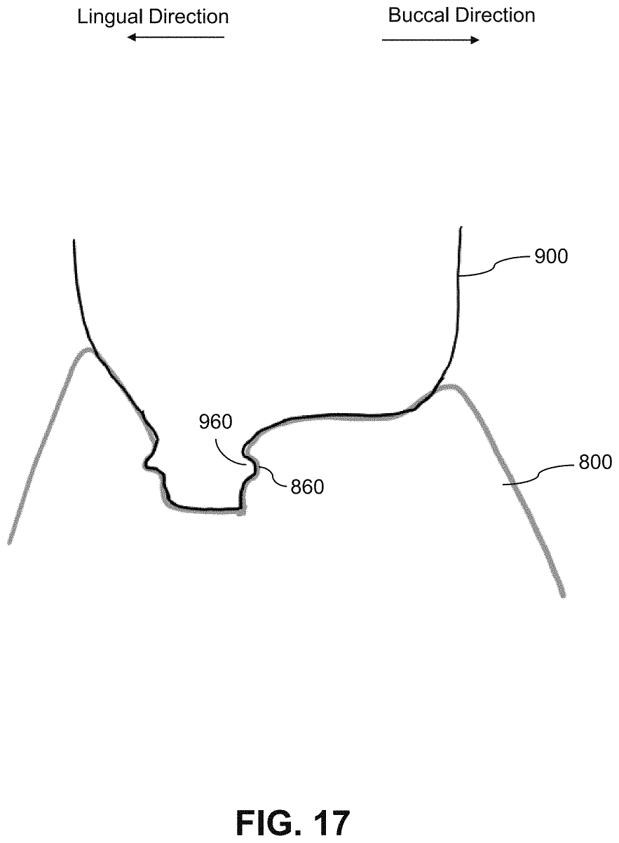

In another illustrative embodiment shown in FIG. 17, the denture tooth 900 and denture base 800 include mating features in the form of a protrusion 960 on the tooth and a corresponding indentation 860 on the denture base. In some embodiments, as the denture tooth is inserted into the socket of the denture base, and the protrusion 960 on the denture tooth snaps into the indentation 860 on the denture base. Mating between the protrusion 960 and indentation 860 may aid in resisting separation of the tooth from the denture base.

It should be appreciated that the mating features may be mixed and matched. For example, the denture tooth may have a protrusion to mate with a corresponding indentation on the denture base, and the denture tooth may also have an indentation to mate with a corresponding protrusion on the denture base.

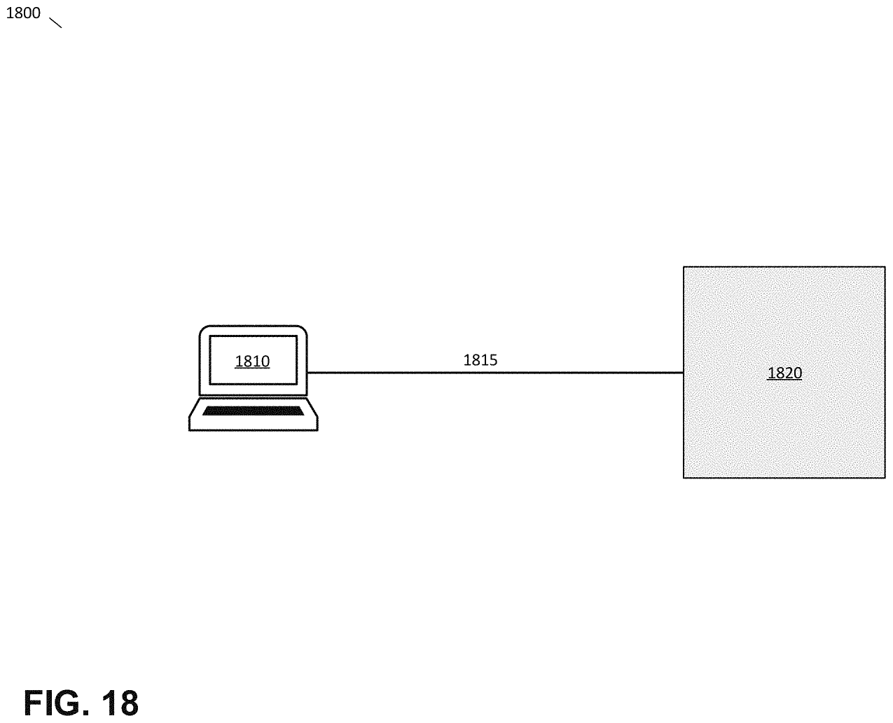

FIG. 18 is a block diagram of a system suitable for practicing aspects of the invention, according to some embodiments. System 1800 illustrates a system suitable for generating instructions to perform additive fabrication by an additive fabrication device and subsequent operation of the additive fabrication device to fabricate a part. For instance, instructions to fabricate a part and a support structure as described by the various techniques above may be generated by the system and provided to the additive fabrication device. Various parameters associated with generating a support structure may be stored by system computer system 1810 and accessed when generating instructions for the additive fabrication device 1820.

It will be appreciated that any of the above-described techniques to generating a support structure may be combined in any suitable manner and in any suitable order. According to some embodiments, computer system 1810 may execute software that generates instructions for fabricating a part using additive fabrication device, such as method 350 shown in FIG. 3B and/or method 700 shown in FIG. 7. Said instructions may then be provided to an additive fabrication device, such as additive fabrication device 1820, via link 1815, which may comprise any suitable wired and/or wireless communications connection. In some embodiments, a single housing holds the computing device 1810 and additive fabrication device 1820 such that the link 1815 is an internal link connecting two modules within the housing of system 1800.

FIG. 19 illustrates an example of a suitable computing system environment 1900 on which the technology described herein may be implemented. For example, computing environment 1900 may form some or all of the computer system 1810 shown in FIG. 18. The computing system environment 1900 is only one example of a suitable computing environment and is not intended to suggest any limitation as to the scope of use or functionality of the technology described herein. Neither should the computing environment 1900 be interpreted as having any dependency or requirement relating to any one or combination of components illustrated in the exemplary operating environment 1900.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 19, an exemplary system for implementing the technology described herein includes a general purpose computing device in the form of a computer 1910. Components of computer 1910 may include, but are not limited to, a processing unit 1920, a system memory 1930, and a system bus 1921 that couples various system components including the system memory to the processing unit 1920. The system bus 1921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1910 typically includes a variety of computer readable media. Computer readable media can be any available media that can be accessed by computer 1910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1930 includes computer storage media in the form of volatile and/or nonvolatile memory such as read only memory (ROM) 1931 and random access memory (RAM) 1932. A basic input/output system 1933 (BIOS), containing the basic routines that help to transfer information between elements within computer 1910, such as during start-up, is typically stored in ROM 1931. RAM 1932 typically contains data and/or program modules that are immediately accessible to and/or presently being operated on by processing unit 1920. By way of example, and not limitation, FIG. 19 illustrates operating system 1934, application programs 1935, other program modules 1936, and program data 1937.

The computer 1910 may also include other removable/non-removable, volatile/nonvolatile computer storage media. By way of example only, FIG. 19 illustrates a hard disk drive 1941 that reads from or writes to non-removable, nonvolatile magnetic media, a flash drive 1951 that reads from or writes to a removable, nonvolatile memory 1952 such as flash memory, and an optical disk drive 1955 that reads from or writes to a removable, nonvolatile optical disk 1956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1941 is typically connected to the system bus 1921 through a non-removable memory interface such as interface 1940, and magnetic disk drive 1951 and optical disk drive 1955 are typically connected to the system bus 1921 by a removable memory interface, such as interface 1950.

The drives and their associated computer storage media discussed above and illustrated in FIG. 19, provide storage of computer readable instructions, data structures, program modules and other data for the computer 1910. In FIG. 19, for example, hard disk drive 1941 is illustrated as storing operating system 1944, application programs 1945, other program modules 1946, and program data 1947. Note that these components can either be the same as or different from operating system 1934, application programs 1935, other program modules 1936, and program data 1937. Operating system 1944, application programs 1945, other program modules 1946, and program data 1947 are given different numbers here to illustrate that, at a minimum, they are different copies. A user may enter commands and information into the computer 1910 through input devices such as a keyboard 1962 and pointing device 1961, commonly referred to as a mouse, trackball or touch pad. Other input devices (not shown) may include a microphone, joystick, game pad, satellite dish, scanner, or the like. These and other input devices are often connected to the processing unit 1920 through a user input interface 1960 that is coupled to the system bus, but may be connected by other interface and bus structures, such as a parallel port, game port or a universal serial bus (USB). A monitor 1991 or other type of display device is also connected to the system bus 1921 via an interface, such as a video interface 1990. In addition to the monitor, computers may also include other peripheral output devices such as speakers 1997 and printer 1996, which may be connected through an output peripheral interface 1995.

The computer 1910 may operate in a networked environment using logical connections to one or more remote computers, such as a remote computer 1980. The remote computer 1980 may be a personal computer, a server, a router, a network PC, a peer device or other common network node, and typically includes many or all of the elements described above relative to the computer 1910, although only a memory storage device 1981 has been illustrated in FIG. 19. The logical connections depicted in FIG. 19 include a local area network (LAN) 1971 and a wide area network (WAN) 1973, but may also include other networks. Such networking environments are commonplace in offices, enterprise-wide computer networks, intranets and the Internet.

When used in a LAN networking environment, the computer 1910 is connected to the LAN 1971 through a network interface or adapter 1970. When used in a WAN networking environment, the computer 1910 typically includes a modem 1972 or other means for establishing communications over the WAN 1973, such as the Internet. The modem 1972, which may be internal or external, may be connected to the system bus 1921 via the user input interface 1960, or other appropriate mechanism. In a networked environment, program modules depicted relative to the computer 1910, or portions thereof, may be stored in the remote memory storage device. By way of example, and not limitation, FIG. 19 illustrates remote application programs 1985 as residing on memory device 1981. It will be appreciated that the network connections shown are exemplary and other means of establishing a communications link between the computers may be used.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets.

As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a non-transitory computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software,” when used herein, are used in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately,” “substantially” and “about” may be used to mean within ±20% of a target value in some embodiments, within ±10% of a target value in some embodiments, within ±5% of a target value in some embodiments, and yet within ±2% of a target value in some embodiments. The terms “approximately,” “substantially” and “about” may include the target value.

What is claimed is:

1. A computer-implemented method of generating three-dimensional models for additive fabrication of a removable partial denture, the method comprising:
obtaining, using at least one processor, a 3-dimensional (3D) model of a denture base of a removable partial denture;
generating, using the at least one processor, at least a first 3D model and a second 3D model each representing a portion of the 3D model of the denture base of the removable partial denture,
wherein generating the first 3D model and the second 3D model comprises geometrically dividing the 3D model of the denture base of the removable partial denture.

2. The method of claim 1, wherein the first 3D model and the second 3D model comprise mutually complementary shapes.

3. The method of claim 1, further comprising:
obtaining, using the at least one processor, a 3D model of a frame of the removable partial denture, and
wherein generating the first 3D model and the second 3D model comprises volumetrically subtracting the 3D model of the frame from the 3D model of the denture base of the removable partial denture and/or from the first 3D model and the second 3D model.

4. The method of claim 1, further comprising generating, using the at least one processor, a third 3D model and a fourth 3D model each representing a portion of the three-dimensional model of the denture base of the removable partial denture, the third 3D model and the fourth 3D model comprising mutually complementary shapes.

5. The method of claim 4,
wherein the first 3D model and second 3D model are configured to mate with one another around a first portion of the 3D model of the frame of the removable partial denture, and
wherein the third 3D model and fourth 3D model are configured to mate with one another around a second portion of the 3D model of the frame of the removable partial denture.

6. The method of claim 5, wherein the first 3D model and second 3D model are configured to mate with one another via their mutually complementary shapes.

7. The method of claim 1, further comprising generating instructions for an additive fabrication device that, when executed by the additive fabrication device, cause the additive fabrication device to fabricate the first 3D model.

8. The method of claim 7, further comprising executing the instructions by the additive fabrication device.

9. The method of claim 7, further comprising fabricating the first 3D model by the additive fabrication device.

10. The method of claim 7, further comprising fabricating the 3D model of the frame of the removable partial denture by the additive fabrication device.

11. The method of claim 10, wherein the 3D model of the frame of the removable partial denture is fabricated by the additive fabrication device from a castable material.

12. The method of claim 10, wherein the 3D model of the frame of the removable partial denture is fabricated by the additive fabrication device from a flexible material.

13. A removable partial denture comprising:
a first denture base portion;
a second denture base portion; and
a frame,
wherein the first denture base portion is coupled to the second denture base portion, with at least a portion of the frame being encapsulated by the coupled first and second denture base portions.

14. The removable partial denture of claim 13, wherein the first denture base portion and the second denture base portion are additively fabricated.

15. The removable partial denture of claim 13, wherein the frame is additively fabricated.

16. The removable partial denture of claim 13, wherein the frame comprises a flexible polymer.

17. The removable partial denture of claim 13, wherein the first denture base portion and the second denture base portion are coupled to one another via an adhesive.

18. The removable partial denture of claim 13, wherein the first denture base portion and the second denture base portion are fused together to form a monolithic structure.

19. The removable partial denture of claim 13, wherein the first denture base portion and the second denture base portion comprise mutually complementary shapes.

20. The removable partial denture of claim 19, wherein the first denture base portion and the second denture base portion interlock with one another via the mutually complementary shapes.

21-80. (canceled)
